(19) United States
(12) Patent Application Publication
(10) Pub. No.: US 2004/0265034 A1
(43) Pub. Date: Dec. 30, 2004

(54) Propelling pencil

(76) Inventor: Liangying Gu, Guangxi (CN)

Correspondence Address: James W. McKee, Esq., Fay, Sharpe, Fagan, Minnich & McKee, LLP, Seventh Floor, 1100 Superior Avenue, Cleveland, OH, 44114-2518, US

(21) Appl. No.: 10/840,729

(22) Filed: May 6, 2004

(30) Foreign Application Priority Data
May 7, 2003 (CN) 03225806.2

(51) Int. Cl. B43K 21/22

(52) U.S. Cl. 401/93; 401/92

(57) ABSTRACT

The present invention relates to a propelling pencil having such a lead feeding mechanism that may feed out the lead automatically by a pressing force and a friction force. A pencil head in which a pencil point is disposed threadly engages with the front end of an outer sleeve that fits over an inner sleeve with clearance fit. The back end of the inner sleeve fits over the front end of a propeller with clearance fit. A damping tube in which a pair of lock sheets is disposed is provided in the back part of the pencil point. Two lock sheets cooperate with each other so that their front ends and back ends may open and close around a mortar and a socket at the center part thereof. The front end of the lock sheet is a locking point for lead feeding, which makes the next lead on the back lie in a following state under the action of gravity, effectively avoiding jam and eliminating noise. After the pencil point has contracted back, the back part of it will get stuck in the opening in the front end of the outer sleeve, making the front part of it not contact with environment and avoiding the lead from being fed out automatically when this pencil is put into pockets or bags.

### BACKGROUND

The present invention relates to writing implements, and in particular, to a propelling pencil having such a lead feeding mechanism that may feed out the lead automatically by a pressing force and a friction force during use.

Conventional pencils made of wood not only have to be chipped repeatedly during use, but also lead to an enormous waste on wood resource. Manual types of pencils solve the problem described above. But when we write with a pencil of this type, we have to press the pencil from time to time. In the meanwhile the lead in this pencil is easily broken, so that the pencil of this type is still not very convenient for use.

The description of the Chinese utility model CN2289687Y discloses an invention named “A propelling pencil of touching type”. This propelling pencil is comprised of an automatic lead feeding device, a pencil head, a pencil shell, a tail button and an eraser. The automatic lead feeding device is made up of a touching mouth, a bridge piece, a leading clamping sheet, a bit, a pencil liner and a compression spring. A number of leads contained in the pencil liner may extend out automatically as they are being consumed during writing, until all the leads have been used up. The pencil of this type has well solved the problem in respect to feeding the lead continuously. But in use, it has been found that the propelling pencil taking this structure has the following disadvantages: firstly, the pencil of this type brings a relatively higher demand on the leads, if the facing end surfaces of two leads that are connected with each other by their end surfaces are not flat surfaces, but bevel surfaces (or spiky surfaces), because the lead on the back pushes the other lead in front of it when it is subjected to force during lead feeding, two bevel surfaces (or spiky surfaces) will stagger in the lead clamping sheet, resulting in jam and the pencil out of use; secondly, when the lead is being fed at the first time or when it is being contracted back, noise may occur when pressing the tail button; thirdly, the pencil point or the touching mouth may not contract back into the pencil head, when the pencil point touches a pocket, a pencil box or a brief case, the lead may extend out automatically and then dirty dresses and the like.

### BRIEF DESCRIPTION

A major aim of the present invention is to provide a propelling pencil even if the facing surfaces of two leads that are connected with each other by their end surfaces in the pencil are not flat surfaces, there will not occur a jam problem in this pencil.

Another aim of the present invention is to provide such a propelling pencil that when the leads contained in the pencil are being fed manually or being contracted back, noise will not occur.

Still another aim of the present invention is to provide such a propelling pencil that the pencil point of this pencil may contract back to facilitate transportation.

In order to achieve the aims described above, the present invention adopts such a technical solution that: a pencil head in which a pencil point is disposed threadly engages with the front end of an outer sleeve that fits over an inner sleeve with clearance fit, the back end of the inner sleeve fits over the front end of a propeller with clearance fit, a damping tube in which a pair of lock sheets is disposed is provided in the back part of the pencil point, two lock sheets cooperate with each other so that their front ends and back ends may open and close around a mortar and a socket at the center part thereof, the front end of the lock sheet is a locking point for lead feeding, which makes the next lead on the back lie in a following state under the action of gravity, effectively avoiding jam.

The back ends of the lock sheets engages with the propeller's front end with a duck mouth like shape, a shoulder is further provided at the center part of the lock sheets, a spring is disposed between the shoulder and the inner sleeve. A conical inner wall outspreading forward is provided in the front part of the inner sleeve, a pair of balls is symmetrically disposed between the inner wall of the inner sleeve and the front part of the lock sheet. In prior art, the bit moves up and down quickly in the shoulders of the assembling tube, which results in undesirable noise, while in the present invention, such movement of the bit has been eliminated, therefore when the propeller is pressing the back end of the lock sheets forward and coming back to it original position, noise will not occur.

A spring is disposed between the shoulder at the back part of the pencil point and the front end surface of the outer sleeve, an opening engaging with the back part of the pencil point through interference fit is provided in the front end of the outer sleeve. Accordingly, after the pencil point has contracted back, the back part of it will get stuck in the opening described above, making the front part of it not contact with environment and avoiding the lead from being fed out automatically when this pencil is put into pockets or bags.

### BRIEF DESCRIPTION OF THE DRAWINGS

Hereafter, the present invention is further described in combination with the attached drawings, which show a preferable embodiment of the present invention.

FIG. 1 is a structural diagram showing the front part of the embodiment;

FIG. 2 is a structural diagram showing the back part of the embodiment;

FIG. 3 is an enlarged diagram showing the structures of a pencil head, a pencil point and a damping tube;

FIG. 4 is a structural diagram showing an outer sleeve;

FIG. 5 is a structural diagram showing an inner sleeve;

FIG. 6 is a structural diagram showing a pair of lock sheets;

FIG. 7 is a structural diagram showing a propeller and a pair of stuck members;

FIG. 8 is a structural diagram showing a lead storing tube;

FIG. 9 is a structural diagram showing an eraser base;

FIG. 10 is a structural diagram showing an eraser;

FIG. 11 is a structural diagram showing a pencil cap;

FIG. 12 is a structural diagram showing one lock sheet;

FIG. 13 is a sectional view along line D-D in FIG. 12;

FIG. 14 is a top view of FIG. 12;

FIG. 15 is a back view of FIG. 12;

FIG. 16 is a sectional view along line A-A in FIG. 12;

FIG. 17 is a sectional view along line B-B in FIG. 12;

FIG. 18 is a sectional view along line C-C in FIG. 12;

FIG. 19 is a structural diagram showing the propeller;

FIG. 20 is a sectional view of FIG. 19;

FIG. 21 is a sectional view along line E-E in FIG. 20;

FIG. 22 is a sectional view along line F-F in FIG. 20.

### DETAILED DESCRIPTION

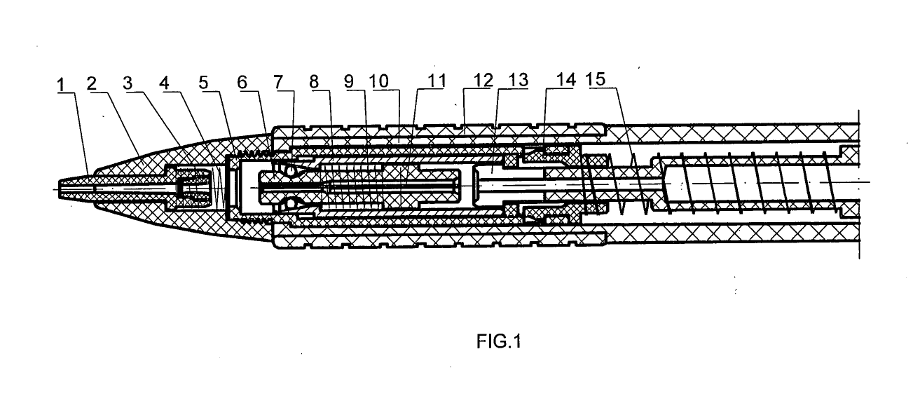

Referring to FIG. 1, a pencil point 1 disposed in a pencil head 2 may move in the inner chamber of the pencil head 2. A damping tube 3 is attached at the tail end of the pencil point 1. A spring 4 is provided in the inner chamber of the pencil head 2. The tail end of the pencil point 1 may enter into an opening at the front end of an outer sleeve 5 with interference fit between them. At this time, the pencil point 1 may contract back into the inner chamber of the pencil head 2, and it may not be ejected out by only the elastic force of the spring 4 due to interference fit. The front end of the outer sleeve 5 threadly engages with the pencil head 2. An inner sleeve 8 is movably disposed in the outer sleeve 5, while a pair of lock sheets 6 is movably disposed in the inner sleeve 8. A spring 9 is provided between the inner sleeve 8 and the lock sheets, and a pair of balls 7 is symmetrically disposed at the front part between them. A pencil stem 10 fits over the periphery of the outer sleeve 5. A supporting part 11 provided at the center part of the lock sheets 6 comprises a mortar and a socket that engage with each other rotatably. An antislip sheath 12 is attached at the front part of the pencil stem 10. The front part of a propeller 13 locates in the back part of the inner sleeve 8. A pair of stuck members 14 gets stuck in the back end of the outer sleeve 5. A spring 15 is provided between the stuck member 14 and the propeller 13.

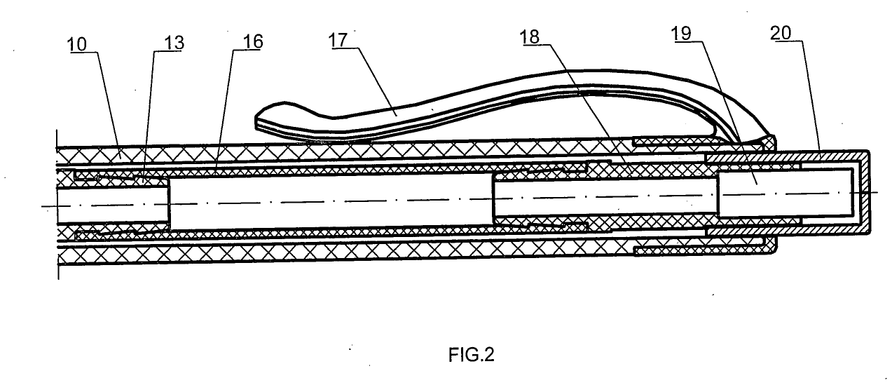

Referring to FIG. 2, the back end of the propeller 13 connects with a lead storing tube 16, the back end of which connects with an eraser base 18. An eraser 19 also used for an end cap of the eraser base 18 may be crammed into the eraser base 18. The root part of a pencil clamp 17 fits over the tail end of the pencil stem 10, while the pencil cap 20 fits over the back end of the eraser base 18.

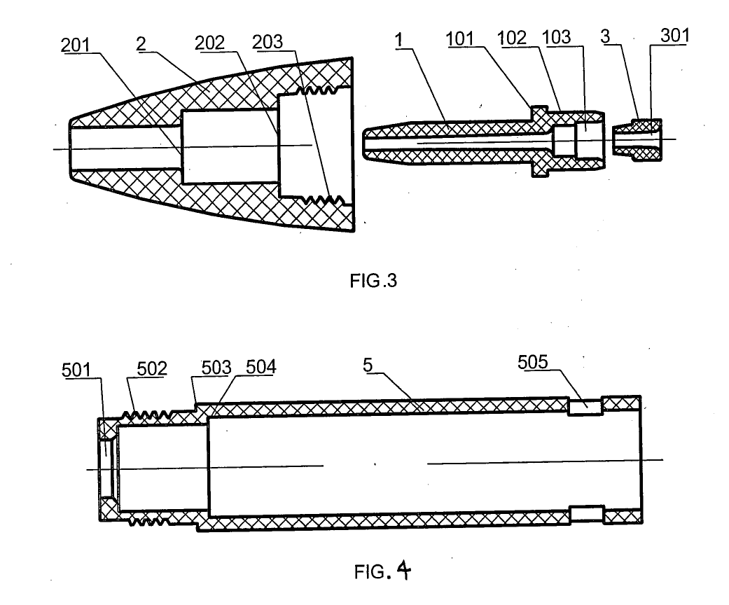

Referring to FIG. 3, a first shoulder 201, a second shoulder 202 and a thread 203 are provided in the inner chamber of the pencil head 2. The first shoulder 201 cooperates with a shoulder 101 on the pencil point 1 so as to limit the maximum amount that the pencil point 1 can extend out. The second shoulder 202 and the thread 203 are used to connect with the outer sleeve 5 and limit the position of it. A tube body 102 is provided at the back of the shoulder 101 on the pencil point 1. An inner chamber of the tube body 102 compresses a damping tube 3, which is flexible and has a high friction force. The bore diameter of an inner passage 301 in the damping tube 3 is smaller than the diameter of the lead.

Referring to FIG. 4, an opening 501 engaging with the tube body 102 on the back part of the pencil point 1 through interference fit, and an outer thread 502 are provided on the front end of the outer sleeve 5. A shoulder 503 cooperates with the terminal of the pencil head 2 to limit the position of the pencil stem 10. An inner shoulder 504 may be provided to limit the movement of the inner sleeve 8 towards forward. A pair of openings 505 on the back part of the outer sleeve 5 may be provided to engage with the protrusions on the stuck members 14.

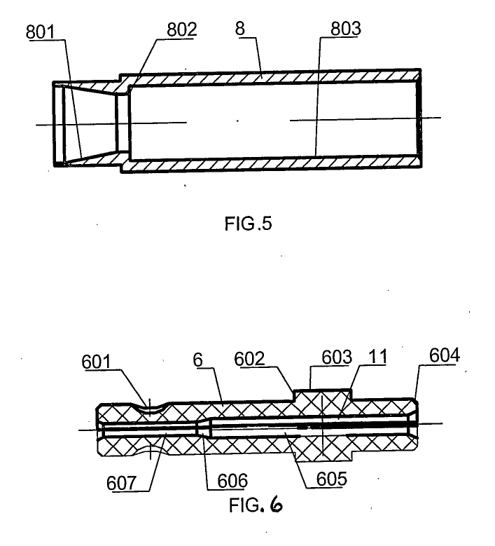

Referring to FIG. 5, at the front part of the inner sleeve 8, there is a flaring, conical inner wall 801, following which is an inner shoulder 802 used as a base for the spring 9, while at the back part of it, there is also a flaring, conical inner wall 803 having a relatively smaller taper. The head of the propeller 13 may be compressed by the inner wall 803 when it advances from the back to the front, which causes the head of the propeller 13 to contract.

Referring to FIG. 6, when a pair of lock sheets 6 combine with each other, their profile are similar with a revolution body, the axis of which is the axis of a lead passing passage. The lead passing passage is comprised of a lead holding section 607 that is smaller in diameter than the lead and that is on the front part of the lead passing passage, a transitional section 606 and a lead containing section 605 that is slightly larger in diameter than the lead. A nest 601 is provided at the front part of either lock sheet 6. The ball may roll between the nest 601 and the conical inner wall 801. A shoulder 602 is a location limiting shoulder, between which and the inner shoulder 802 a spring 9 is disposed. The diameter of a projecting ring 603 is slightly smaller than the inner diameter of the inner sleeve 8. The supporting part 11 is a component made up of a mortar and a socket, and its structure will be described hereafter. The supporting part 11 is like a fulcrum, when the front ends of two lock sheets contact with each other, the back ends 604 of them will spread out.

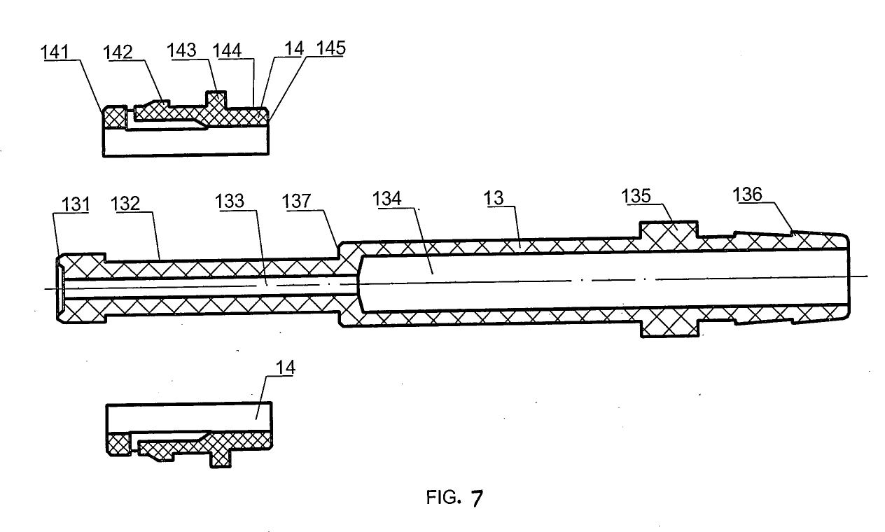

Referring to FIG. 7, the propeller 13 comprises a front end 131 with a duck mouth like shape, a stem 132 cooperating with the stuck member 14, a lead containing chamber 134 and a lead feeding tube 133. On one hand, a projecting ring 135 supported by the propeller 13 slides in the pencil stem; on the other hand, the shoulder on the left side of it presses the spring. A pair of the stuck members 14 may relatively move in the space interval of the stem 132. The front end 141 of the member 14 limits the position of the back end of the inner sleeve 8, while the back end 145 of it limits the position of the shoulder 137 on the propeller 13. The elastic projection 142 extending in the radial direction engages into the opening on the back end of the outer sleeve. On one hand, the projecting ring 143 abuts against the terminal of the outer sleeve; on the other hand, the ring 143 and the projecting ring 135 commonly limit the position of the spring 15. A ring surface 144 is provided to secure the root part of the spring 15.

Referring to FIG. 8, the lead storing tube 16 is the tube having a uniform diameter. The front end of the tube 16 connects with the propeller, while the back end of it connects with the eraser base.

Referring to FIG. 9, the left end of the eraser base 18 inserts into the lead storing tube tightly. The pencil cap connects with the outside of the right end of the eraser base 18, while the eraser connects with the inside of it.

Referring to FIG. 10, the eraser 19 is a cylindrical body.

Referring to FIG. 11, the pencil cap 20 is a barrel one side of which is sealed.

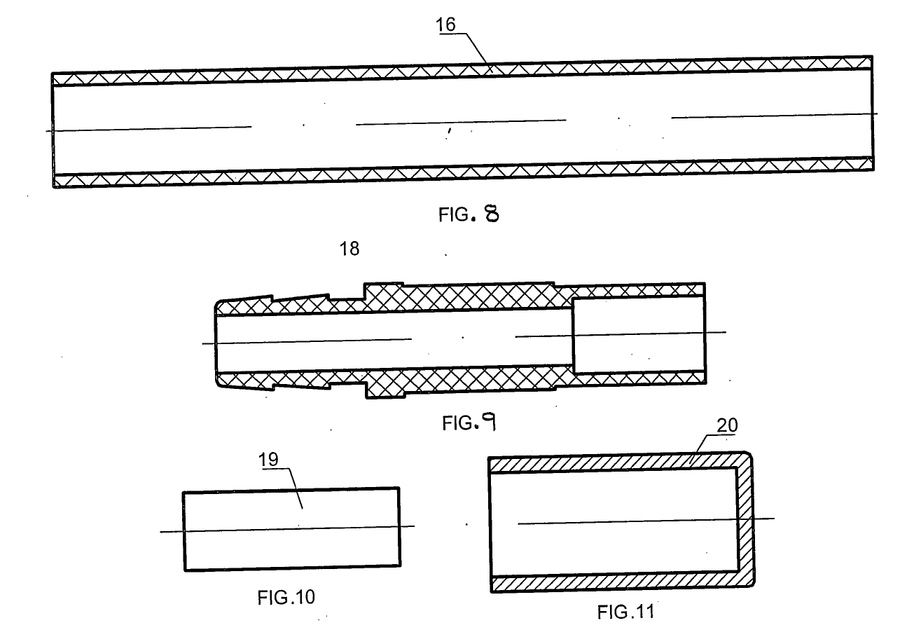

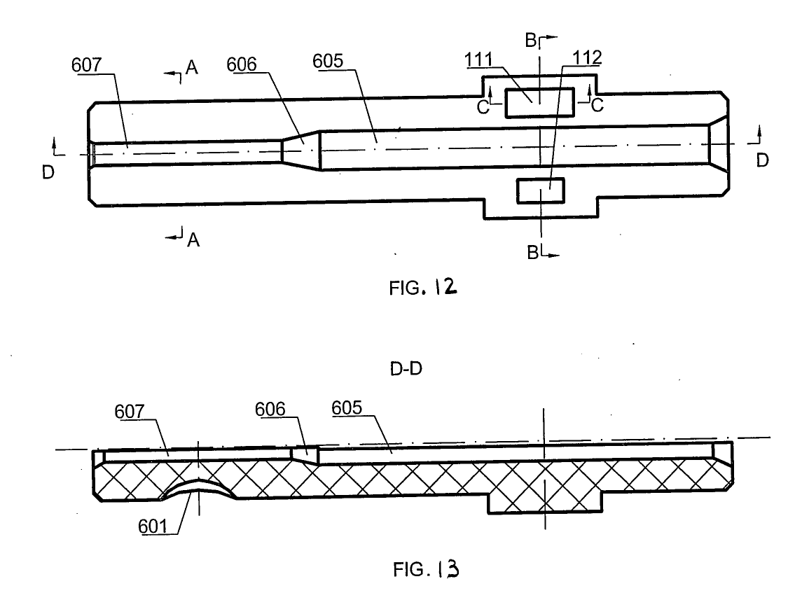

Referring to FIG. 12, along the center line of either lock sheet, there is a groove comprising the lead holding section 607, the transitional section 606 and the lead containing section 605. The supporting part 11 is comprised of the socket 111 and the mortar 112, which are on two sides of the lead passing groove respectively.

Referring to FIG. 13, the horizontal axis locates above the groove, and the nest 601 locates right below the groove.

Referring to FIG. 14, the mortar 112 is a curved lug.

Referring to FIG. 15, the nest 601 is a hemispherical recess.

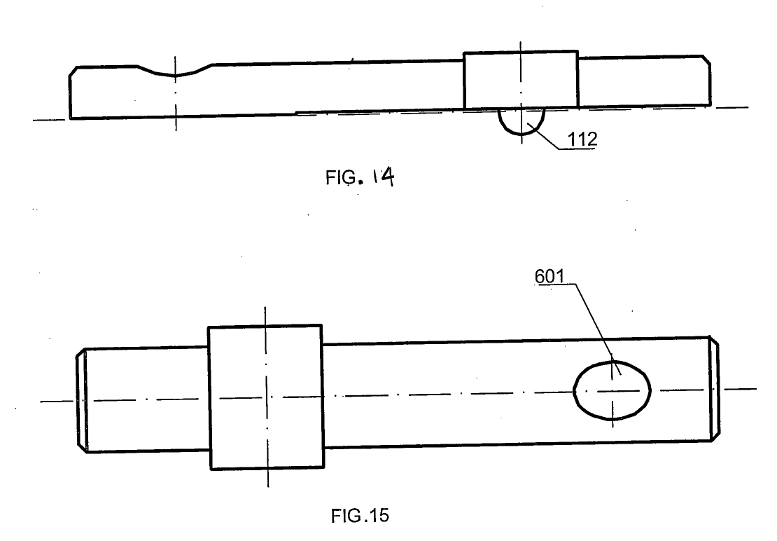

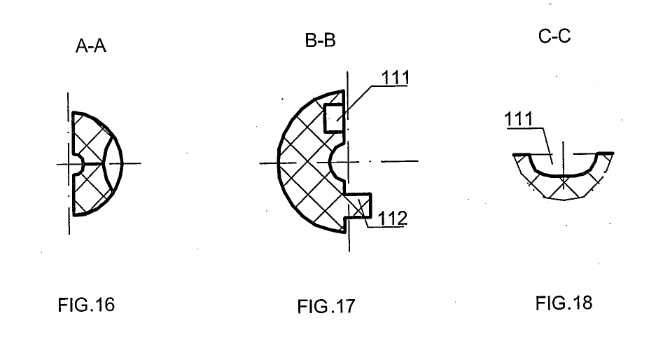

Referring to FIG. 16, the lead holding section in either lock sheet is a semicircular body. The groove in this section has a sectional area smaller than the semicircle. The diameter of the circle comprised of two semicircles is slight smaller than that of the lead, therefore when two lock sheets close with each other at this section, the lead may be clamped tightly.

Referring to FIG. 17, the groove in the containing section also has a sectional area smaller than the semicircle. But the diameter of the circle comprised of these two semicircles is larger than that of the lead, therefore when two lock sheets close with each other at the terminal thereof, they still can and only can contain one lead. When the socket 111 and the mortar 112 disposed skewsymmetrically combine with each other, they will form a supporting part.

Referring to FIG. 18, the lengthwise section of the socket 111 has an oval shape, which facilitates the mortar to roll in the socket 111.

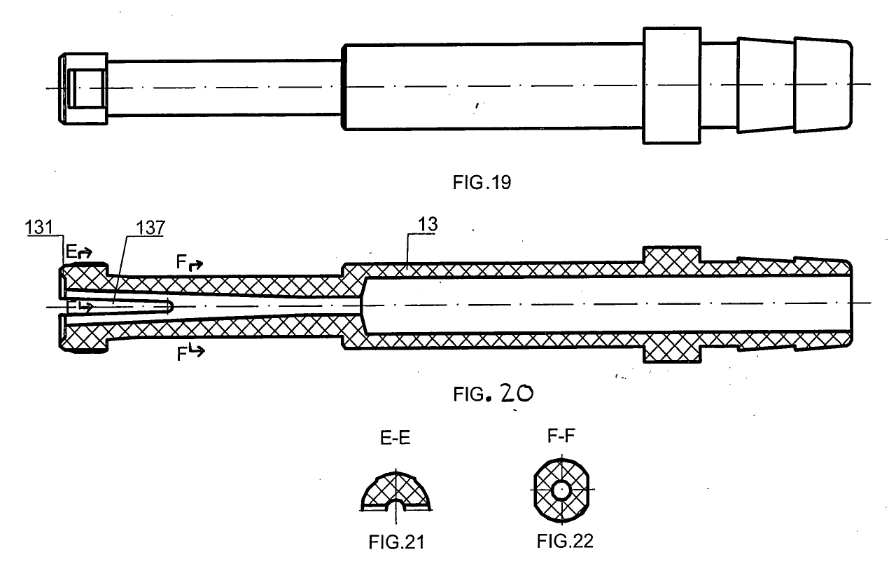

Referring to FIGS. 19 and 20, the propeller 13 has a head end 131 with a duck mouth like shape. An opening 137 that may open and close extends backward from the head end 131. Accordingly, when the head end 131 lies in the inner sleeve 8, it will be radially compressed against the conical inner wall 803 of the inner sleeve 8 by an elastic tension.

Referring to FIG. 21 and 22, the lead passing passage can contain only one lead.

Hereafter, the operating principle of the present invention will be described in combination with the structural features of it. Referring to FIGS. 1 and 2, a number of the leads (not shown) may be contained in the lead containing tube 16, but only one lead may enter into the lead passing passage at the front part of the propeller 13 until its front end arrives at the transitional section 606 of the lock sheets 6 (Referring to FIG. 6). The lock sheets 6 lies in a contracted state due to the action of the spring 9, that is, it will move towards the right direction as illustrated. And then, the front end of the lock sheets 6 will close with each other around the supporting part 11 under the compressive force applied by the conical inner wall 801 at the front part of the inner sleeve 8 through the balls 7, therefore the lead cannot pass by. At this time, if pressing the pencil cap 20, the propeller 13 will move forward, and the head end 131 of it will push the lock sheets 6 to move forward relative to the inner sleeve 8. At the same time, as the head end 131 with a duck mouth like shape is moving forward along the flaring back end of the inner sleeve 8, it is subjected to a compressive force, which makes the back ends of the lock sheets rotationally close with each other around the supporting part 11. Accordingly, the front ends of the lock sheets will open, allowing the lead to pass by until the head end of it arrives at the damping tube 3. Then the pencil cap 20 is released. The lead keeps stationary relative to the damping tube 3, and other parts comes back to their original positions respectively. At this time, the lock sheets 6 clamp the lead tightly. When pressing the pencil cap 20 once again, the propeller 13 will push the inner sleeve 8 forward due to the tension of its head end 131. During the movement of the sleeve 8, the lock sheets 6 will move forward along with the sleeve 8. Then, the lead will pierce into the damping tube 3, which clamps the head end of the lead tightly. At the same time, the outer shoulder of the inner sleeve 8 arrives at the inner shoulder 504 of the outer sleeve 5, limiting the position of the sleeve 8. Similarly, the shoulder 137 of the propeller 13 arrives at the inner shoulder 145 of the stuck member 14, limiting the position of the propeller 13. Then, the pencil cap 20 is released. The lead still keeps stationary relative to the damping tube 3, and other parts comes back to their original positions respectively. The lock sheets 6 clamp the lead tightly once again. When the pencil point contacts the paper, it will contract back together with the lead in it. Accordingly, because the lock sheets 6 clamp the lead tightly, it will contract back relative to the inner sleeve 8 as the lead contracts back, which results in the front ends of the lock sheets 6 close with each other tightly. Then, as the pencil point 1 further contracts back, the lead will move a length into the pencil point 1. When the pencil point 1 moves away from the paper surface, because both the friction force that the damping tube 3 applies to the lead and the tension of the spring 3 are larger than the tension of the spring 9, the lead will move a length forward relative to the lock sheets 6. After the operation described above has repeated a number of times, the lead will extend out of the left end of the pencil point 1. During writing, the lead tends to moving back when it contacts the paper surface, which causes the lock sheets 6 to clamp the lead tightly and therefore prevents the lead from moving back. After writing, the pencil cap 20 is pressed to push the lock sheets 6 forwards, therefore the lock sheets 6 will not clamp the lead tightly. And then, the pencil point 1 may be pressed against an object or a finger until it moves back sufficiently to get stuck in the opening at the front end of the outer sleeve 5. The friction force between the pencil point 1 and the opening at the front end of the outer sleeve 5 overcomes the tension of the spring 4 and makes the pencil point 1 contract back into the chamber of the pencil head 2. Therefore, when putting this pencil in the pockets or bags, the lead will not be fed out unintentionally. When writing once again using this pencil, what needs to be done is pressing the pencil cap 20 to make the front end of the lock sheets 6 abut against the back end of the pencil point 1, and making the pencil point 1 separate from the opening at the front end of the outer sleeve 5 against the friction, which causes the back end of the pencil point 1 engages into that opening through interference fit. After these, the operation described above for feeding out the lead may be performed.

1. A propelling pencil comprising:
a pencil head (2) in which a pencil point (1) is disposed, the pencil head (2) threadly engages with the front end of an outer sleeve (5) that fits over an inner sleeve (8) with clearance fit, the back end of said inner sleeve (8) fits over the front part of a propeller (13) with clearance fit, a damping tube (3) is provided in the back part of said pencil point (1);
a pair of lock sheets (6) is provided in said inner sleeve (8), two lock sheets (6) cooperate with each other so that their front ends and back ends may open and close around a mortar and a socket at the center part thereof, the back ends of said lock sheets (6) engages with said propeller's (13) front end, a shoulder is further provided at the center part of said lock sheets (6), a spring (9) is disposed between said shoulder and said inner sleeve (8);
a conical inner wall outspreading forward is provided in the front part of said inner sleeve (8), a pair of balls (7) is symmetrically disposed between said inner wall and the front part of said lock sheets (6), a conical inner wall outspreading backwards is provided in the back part of said inner sleeve (8); and
a spring (4) is disposed between said shoulder at the back part of said pencil point (1) and the front end surface of said outer sleeve (5), an opening engaging with the back part of said pencil point (1) through interference fit is provided at the front end of said outer sleeve (5).

2. The propelling pencil according to claim 1 further comprising: a lead passing groove extending axially is formed on the junction plane of said lock sheets (6), the front part of the groove is relatively smaller in diameter, the back part of it is relatively larger in diameter.

3. The propelling pencil according to claim 2, wherein the front end of said lead passing groove has a section smaller than the lead.

4. The propelling pencil according to claim 1, wherein the back end of said pencil point (1) may engage into the opening at the front end of said outer sleeve (5) through interference fit, the maximum size of the section at the front part of said lock sheets (6) is smaller than the diameter of the opening at the front end of said outer sleeve (5).

5. The propelling pencil according to claim 1, further comprising: a pair of stuck members (14) engaging with the back end of said outer sleeve (5) through a pair of protrusions thereof, said stuck members (14) may keep the front end of said propeller (13) in said inner sleeve (8), an eraser (19) has been crammed into the opening back end of an eraser base (18).

6. The lead propelling pencil according to claim 1, further comprising: a pencil stem (10) fitting over said outer sleeve (5).

7. A lead propelling pencil comprising:
a pencil point (1);
a pencil head (2) in which the pencil point (1) is disposed;
an outer sleeve and an inner sleeve, the outer sleeve fitting over the inner sleeve and the pencil head threadly engaging the front end of the outer sleeve;
a propeller, the back end of the inner sleeve fitting over the front part of the propeller;
a damping tube provided in the back part of the pencil point; and
a pair of lock sheets (6) provided in said inner sleeve (8), the two lock sheets (6) cooperating with each other so that their front ends and back ends may open and close around a mortar and a socket at the center part thereof, the back ends of said lock sheets (6) engaging with the propeller's (13) front end,
wherein the front end of the lock sheets provides a locking point for feeding lead.

8. The lead propelling pencil according to claim 7, further comprising: a lead passing groove extending axially formed on the junction plane of the lock sheets (6), the front part of the groove is smaller in diameter than the diameter of the back part of the groove.

9. The lead propelling pencil according to claim 8, wherein the front end of the lead passing groove has a section smaller than the lead.

10. The lead propelling pencil according to claim 7, wherein the back end of the pencil point (1) engages into the opening at the front end of the outer sleeve (5) through an interference fit, the maximum size of the section at the front part of the lock sheets (6) is smaller than the diameter of the opening at the front end of the outer sleeve (5).

11. The lead propelling pencil according to claim 7, further comprising:
a pair of stuck members (14) engaging the back end of the outer sleeve (5) through a pair of protrusions thereof, wherein the stuck members (14) keep the front end of the propeller (13) in the inner sleeve (8);
an eraser base (18); and
eraser (18), wherein the eraser is crammed into the opening back end of the eraser base (18).

12. The lead propelling pencil according to claim 1, further comprising:
a pencil stem (10) fitting over said outer sleeve (5).

13. The lead propelling pencil according to claim 7, further comprising:
a shoulder at the center part of the lock sheets (6);
a spring (9) disposed between the shoulder and the inner sleeve (8);
a conical inner wall, outspreading forward, provided in the front part of the inner sleeve (8);
a pair of balls (7) symmetrically disposed between the inner wall and the front part of the lock sheets (6); and
a conical inner wall, outspreading backwards, provided in the back part of the inner sleeve (8),
wherein the propeller advances the lead with minimal noise.

14. The lead propelling pencil according to claim 13, further comprising:
a spring (4) disposed between the shoulder at the back part of the pencil point (1) and the front end surface of said outer sleeve (5); and
an opening at the front end of the outer sleeve, engaging the back part of the pencil point (1),
wherein the opening prevents the lead from being fed out when not in use.

15. The lead propelling pencil according to claim 7, further comprising:
a spring (4) disposed between the shoulder at the back part of the pencil point (1) and the front end surface of said outer sleeve (5); and
an opening at the front end of the outer sleeve, engaging the back part of the pencil point (1),
wherein the opening prevents the lead from being fed out when not in use.

16. A lead propelling pencil comprising:
a pencil point (1);
a pencil head (2) in which the pencil point (1) is disposed;
an outer sleeve and an inner sleeve, the outer sleeve fitting over the inner sleeve and the pencil head threadly engaging the front end of the outer sleeve;
a propeller, the back end of the inner sleeve fitting over the front part of the propeller;
damping tube provided in the back part of the pencil point; and
means for providing a locking point for feeding lead.

17. The lead propelling pencil according to claim 16, further comprising:
a lead passing groove extending axially formed on the junction plane of the lock sheets (6), the front part of the groove is smaller in diameter than the diameter of the back part of the groove.

18. The lead propelling pencil according to claim 16, further comprising:
a shoulder at the center part of the lock sheets (6);
a spring (9) disposed between the shoulder and the inner sleeve (8);
a conical inner wall, outspreading forward, provided in the front part of the inner sleeve (8);
a pair of balls (7) symmetrically disposed between the inner wall and the front part of the lock sheets (6); and
a conical inner wall, outspreading backwards, provided in the back part of the inner sleeve (8),
wherein the propeller advances the lead with minimal noise.

19. The lead propelling pencil according to claim 17, further comprising:
means for preventing the lead from being fed out when not in use.

20. The lead propelling pencil according to claim 16, further comprising:
means for preventing the lead from being fed out when not in use.
